(19) United States
(12) Patent Application Publication
(10) Pub. No.: US 2026/0029198 A1
(43) Pub. Date: Jan. 29, 2026

(54) METHOD FOR HEATING A FURNACE

(71) Applicant: ArcelorMittal, Luxembourg (LU)

(72) Inventors: Francisco Javier LAGO FERNANDEZ, Perlavia Asturias (ES); Pedro PRENDES, Gijon Asturias (ES); Jon REYES, Bilbao (ES); Victor CUERVO PINERA, Aviles (ES)

(21) Appl. No.: 18/997,905

(22) PCT Filed: Aug. 1, 2023
(86) PCT No.: PCT/IB2023/057781

§ 371 Date: Jan. 23, 2025

(30) Foreign Application Priority Data
Aug. 2, 2022 (WO) PCT/IB2022/057148

(51) Int. Cl. F27B 3/26; C25B 1/042; F27B 9/06; F27D 17/13

(52) U.S. Cl. CPC F27B 3/26; C25B 1/042; F27B 9/068; F27D 17/13

(57) ABSTRACT

A method for heating a furnace including radiant tubes and being able to thermally treat a running steel strip including the steps of: i. supplying at least one of the radiant tubes with H₂ and O₂ such that the H₂ and the O₂ get combined into heat and steam, ii. recovering the steam from the at least one of the radiant tubes, iii. electrolysing the steam to produce H₂ and O₂, and iv. supplying at least one of the radiant tubes with the H2 and O2 produced in step iii, such that they get combined into heat and steam.

The present invention relates to a method for heating a furnace comprising radiant tubes.

### BACKGROUND

During its manufacturing, a steel strip undergoes thermal treatments to achieve the desired properties. The thermal treatment installations comprise heating means such as Direct Fire Furnace (DFF), Drop Tube Furnace (DTF) and Radiant Tubes Furnace (RTF).

For some thermal treatments, such as annealing, the use of radiant tubes furnace is preferred. Indeed, in such furnace, the strip does not come in direct contact with the combustion products of the flame. Moreover, it allows to control the atmosphere inside the furnace.

### SUMMARY OF THE INVENTION

Radiant tubes are normally fired using gaseous fuels or oil. However, recent developments led to radiant tubes consuming H₂ and O₂ to generate heat. Unfortunately, the production of H₂ from natural resources requires a lot of energy and lead to greenhouse gas emissions.

Consequently, there is a need to develop a method for heating a furnace comprising radiant tubes having a reduced impact on the environment.

The present invention relates to a method for heating a furnace comprising radiant tubes and being able to thermally treat a running steel product comprising the steps of:
i. supplying at least one of said radiant tubes with H₂ and O₂ such that said H₂ and said O₂ get combined into heat and steam,
ii. recovering said steam from said at least one of said radiant tubes,
iii. electrolysing said steam so as to produce H₂ and O₂,
iv. supplying at least one of said radiant tubes with said H₂ and O₂ produced in step iii, such that they get combined into heat and steam.

The method for heating a furnace refers to a method for providing heat to the inside of a furnace so as to achieve a temperature allowing thermal treatment of a running steel strip.

The invention also provides an installation able to perform the method described hereabove, and comprising:
a furnace comprising at least one radiant tube and being able to thermally treat a running steel product,
an electrolysing device able to electrolyse steam and to produce H₂ and O₂
   wherein said electrolysing device is connected to said radiant tube such that at least two flux of gas can flow from the electrolysing device to the radiant tube and one flux of gas can flow from the radiant tube to the electrolysing device and wherein said furnace is configured to supply at least one of said radiant tube with H₂ and O₂ such that said H₂ and O₂ can get combined into heat and steam, and wherein said furnace is configured to recover said steam from said at least one of said radiant tubes.

### BRIEF DESCRIPTION OF THE DRAWINGS

FIG. 1 shows schematically the installation, having a furnace 1 comprising radiant tubes 2, an electrolysing device 3.

FIG. 2 shows schematically a solid oxide electrolyser cell.

FIG. 3 shows schematically a solid oxide electrolyser cell.

### DETAILED DESCRIPTION

The method is performed in an installation, as illustrated in FIG. 1, having a furnace 1 comprising radiant tubes 2, an electrolysing device 3 able to electrolyse steam and to produce H₂ and O₂, such as a Solid Oxide Electrolyser Cells (SOEC), and pipes. Optionally, the installation can comprise pumping system to ease the flow of the gases.

The radiant tubes 2 are connected, via pipes, to the electrolysing device 3 such that at least two flux of gas 4, 4′ can flow from the electrolysing device 3 to the furnace 1, e.g. to the radiant tubes 2, and one flux of gas 5 can flow from the furnace 1, e.g. the radiant tubes 2, to the electrolysing device 3. Moreover, the furnace 1 is preferably connected to means able to supply H₂ and O₂ such as an external supply of H₂ and to an external supply of O₂.

Optionally, storage means 104, shown solely schematically, can be used between the furnace 1 and the electrolysing device 3 to store, at least partly, at least one of the products of the electrolysis.

Preferably the running steel product is a running steel strip or a running steel slab.

The furnace 1 is designed to perform thermal treatment of a steel product such as an annealing of a steel strip or a heating of a steel slab. Preferably, the furnace 1 is an annealing furnace. The radiant tube is part of a radiant tube burner. Preferably, the radiant tube burner is an oxyfuel radiant tube burner.

In the step i., as illustrated in FIG. 1, at least a radiant tube is supplied with H₂ and O₂. Those two gases are combined by the radiant tube into heat and steam. The H₂ and O₂ are supplied from a storage and/or from the electrolysing device. The steam is essentially composed of H₂O molecules.

Preferably, in step i, the at least one of said radiant tubes is supplied with H₂ and O₂ in conditions allowing their ignition and thus the combination into heat and steam. The person skilled in the art is able to determine the parameters leading to the ignition of H₂ and O₂.

For example, the furnace 1 can comprise a radiant tube burner supplied with said H₂and O₂. The radiant tube burner can produce a pilot flame or a spark which permits to ignite said supplied H₂ and O₂ and thus lead to the combination into heat and steam.

Alternatively, O₂ can be supplied with a temperature from at least 550° C., preferably with a temperature from at least 600° C. and even more preferably from at least 700° C. The H₂ can be supplied at a temperature from room temperature, preferably at least of 200° C., more preferably of at least 300° C. and even more preferably of 400° C. The alternative has been developed with the intent to produce a synergically effect between the three first process steps. Indeed, heating the O₂ and H₂ in step i. permits to increase the temperature of the recovered steam in the step ii. and thus increase the efficiency of the electrolysis of step iii. On the contrary, in the state of the art, development discloses processes wherein the gases are supplied at low temperature, such as in WO2016102825, to increase the energy efficiency of the process.

The furnace 1 can comprise at least an oxyfuel burner, such as an oxyhydrogen burner, having a radiant tube. The oxyhydrogen burner can comprise heat exchanger able to heat the gases between the burner inlet and the burner nozzle.

Preferably, the radiant tube burner can preheat the O₂ and optionally the H₂ that is supplied to the radiant tube burner. Therefore, the first step can also comprise the step of preheating the supplied O₂ and optionally the supplied H₂ prior to the combination, e.g. the ignition.

In the step ii., the steam is recovered from the radiant tube to be used in a further step.

However, H₂ and/or O₂ can be present in the steam due to incomplete combustion and/or not optimal O₂/H₂ ratio. Also, the steam can comprise residues from past combustion inside the radiant tube. This is especially true if the radiant tube has been operated with oil or natural gas.

In step iii., the steam recovered in step ii., is electrolysed to produce H₂ and O₂. A portion of the produced H₂ and O₂ can be flown to storage means.

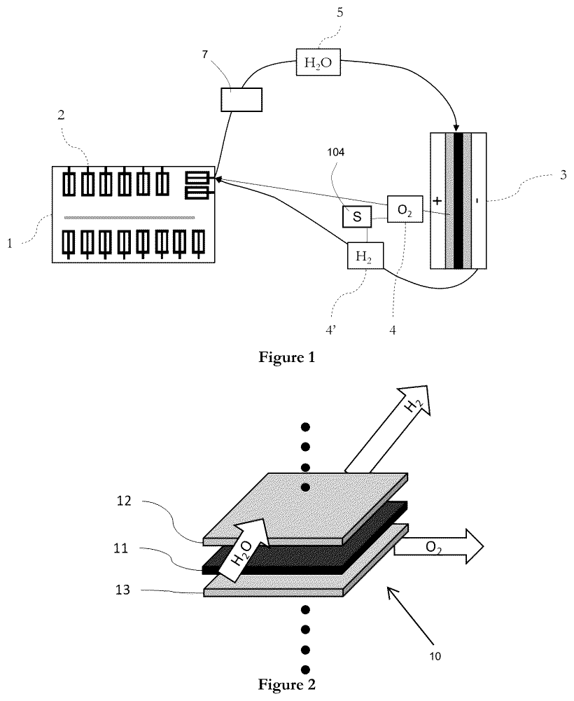

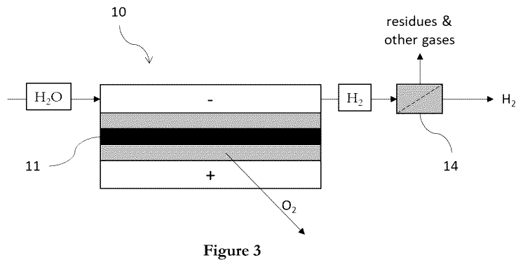

Preferably, said electrolysis is performed by means of at least one solid oxide electrolyser cell. As illustrated in FIGS. 2 and 3, a solid oxide electrolyser cell 10 uses a solid ceramic material as an electrolyte 11 that selectively conducts negatively charged oxygen ions (O₂⁻) or positively charged hydrogen protons (H⁺) depending on the membrane type, e.g. oxygen-ion conducting membrane or proton-conducting membrane respectively).

The steam at the cathode 12 combines with electrons from the external circuit to form hydrogen gas and negatively charged oxygen ions. The reaction at the cathode is thus: H₂O+2e⁻>H₂+O₂⁻. As the steam can comprises other gases and/or residues, the H₂ exiting the electrolysing device can be filtered by means of a membrane separator 14 as illustrated schematically in FIG. 3.

Then the charged oxygen ions pass through the solid ceramic membrane 11 and react at the anode 13 to form oxygen gas and generate electrons for the external circuit. The reaction at the anode is thus: 2 O₂⁻>O₂+4e⁻.

This is preferably performed at elevated temperature and permits to generate hydrogen and oxygen from steam.

This electrolysis reaction is endothermic, so it requires an external energy input for it to occur, e.g. heat and/or electricity. Therefore, it is particularly advantageous to do this electrolysis with steam exiting a furnace having a high temperature.

Alternatively, the electrolysis in step iii can be performed by means of a water vapour electrolyser using electrodes made of porous metal with an electrolyte from composite ionic materials. This system permits advantageously in step iii. electrolysis of a steam having a temperature greater than 300° C. Preferably, the steam electrolysed in step iii. is electrolysed by a water pour electrolyser and has a temperature from 300° C. to 1000° C., more preferably from 400° C. to 1000° C.

In step iv., at least one radiant tube of the installation is supplied with H₂ and O₂ produced in the step iii.

Preferably, in step ii., the recovered steam is heated to a temperature from 650° C. to 1000° C. Even more preferably, the recovered steam is heated to a temperature from 700° C. to 1000° C. Such heating of the recovered steam permits to increase the efficiency of a SOEC.

In this case, the installation comprises a heating means able to heat the recovered steam. Preferably, in step ii. said heating of said recovered steam is performed by heating means being powered in part or all by CO₂ neutral electricity.

For example, the heating means can be a heat exchanger 7 (shown solely schematically in FIG. 1) connected to the radiant tube 2 and the electrolysing device 3 to heat a gas flow from the radiant tube 2 before entering the electrolysing system.

Preferably, the steam electrolysed in step iii. has a temperature from 650° C. to 1000° C. and even more preferably, from 700° C. to 1000° C.

Preferably, in step iii., the electrolysis of steam is powered in part or all by CO₂ neutral electricity.

CO₂ neutral electricity includes notably electricity from renewable source which is defined as energy that is collected from renewable resources, which are naturally replenished on a human timescale, including sources like sunlight, wind, rain, tides, waves, and geothermal heat. In some embodiments, the use of electricity coming from nuclear sources can be used as it is not emitting CO₂ to be produced.

Preferably, in step iv., the said radiant tube is supplied with the H₂ and the O₂ produced in step iii, and with H₂ and/or O₂ from a storage means, such that they get combined into heat and steam.

Preferably, the step ii., iii. and iv. are repeated.

The use of a radiant tube consuming H₂ and O₂ in a quasi-closed loop allows to heat a furnace in a manner requiring less energy and natural resources compared to heating method of the state of the art.

The present invention also relates to an installation able to perform the method described hereabove, and comprising:
a furnace 1 comprising at least one radiant tube 2 and being able to thermally treat a running steel product,
an electrolysing device 3 able to electrolyse steam and to produce H₂ and O₂ wherein said electrolysing device is connected to said radiant tube 2 such that at least two flux of gas (4 and 4′) can flow from the electrolysing device 3 to the radiant tube 2 and one flux of gas 5 can flow from the radiant tube 2 to the electrolysing device and wherein said furnace is configured to supply at least one of said radiant tube 2 with H₂ and O₂ such that said H₂ and O₂ can get combined into heat and steam, and wherein said furnace is configured to recover said steam from said at least one of said radiant tubes.

Preferably, said furnace is configured to supply at least one of said radiant tubes with said H₂ and O₂ produced in step iii. such that they get combined into heat and steam.

Preferably, said furnace is able to treat a running steel strip or a running steel slab.

The furnace 1 can comprise at least an oxyfuel burner, such as an oxyhydrogen burner, having a radiant tube. The oxyhydrogen burner can comprise a heat exchanger able to heat the gases between the burner inlet and the burner nozzle. The radiant tube is part of a radiant tube burner. Preferably, the radiant tube burner is an oxyfuel radiant tube burner.

Preferably, said electrolysing device 3 comprises at least one Solid Oxide Electrolyser Cell.

Preferably, said installation comprises heating means able to heat steam, wherein said heating means is connected to said furnace 1 and to said electrolysing device 3.

Preferably, said installation comprises at least a storage means able to store a gas and being connected to said electrolysing device 3 such that a flow of gas can flow from the electrolysing device 3 to said storage means.

Even more preferably, said at least storage means is connected to said furnace 1 such that a flow of gas can flow from said storage means to said furnace 1.

What is claimed is:

1-12. (canceled)

13. A method for heating a furnace comprising at least one radiant tube and being able to thermally treat a running steel product, the method comprising the steps of:
i. supplying at least one of the radiant tubes with H2 and O2 such that the H2 and the O2 are combined into heat and steam;
ii. recovering the steam from the at least one of the radiant tubes;
iii. electrolysing the steam to produce H2 and O2; and
iv. supplying at least one of the radiant tubes with the H2 and O2 produced in step iii, such that the H2 and O2 are combined into heat and steam.

14. The method according to claim 13 wherein in step ii., the recovered steam is heated to a temperature from 650° C. to 1000° C.

15. The method according to claim 14 wherein in step ii., the recovered steam is heated to a temperature from 700° C. to 1000° C.

16. The method according to claim 13 wherein in step iii., the electrolysis is performed by at least one solid oxide electrolyser cell.

17. The method according to claim 13 wherein, in step iv., the radiant tube is supplied with the H2 and the O2 produced in step iii, and with H2 or O2 from a storage.

18. The method according to claim 13 wherein in step iii., the electrolysis of the steam is powered in part or all by CO2 neutral electricity.

19. The method according to claim 14 wherein in step ii., the heating of the recovered steam is performed by a heater being powered in part or all by CO2 neutral electricity.

20. An installation able to perform the method as recited in claim 13, the installation comprising:
the furnace comprising at least one radiant tube, the furnace able to thermally treat a running steel product;
an electrolyzer able to electrolyse steam and to produce H2 and O2, the electrolyzer being connected to the radiant tube such that at least two fluxes of gas can flow from the electrolyzer to the radiant tube and one flux of gas can flow from the radiant tube to the electrolyzer, the furnace being configured to supply the at least one radiant tube with H2 and O2 such that the H2 and O2 are capable of being combined into heat and steam, the furnace being configured to recover the steam from the at least one radiant tube.

21. The installation according to claim 20 wherein the electrolyzer includes at least one solid oxide electrolyser cell.

22. The installation according to claim 20 further comprising a heater to heat steam, wherein the heater is connected to the furnace and the electrolyzer.

23. The installation according to claim 20 wherein the installation includes a storage able to store gas and connected to the electrolyzer such that a flow of gas can flow from the electrolyzer to the storage.

24. The installation according to claim 23 wherein the storage is connected to the furnace such that a flow of gas can flow from the storage to the furnace.
